(19) United States
(12) Patent Application Publication
(10) Pub. No.: US 2009/0153812 A1
(43) Pub. Date: Jun. 18, 2009

(54) POSITIONING APPARATUS, EXPOSURE APPARATUS, AND DEVICE MANUFACTURING METHOD

(75) Inventor: Tomohiko Yoshida, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/334,762

(22) Filed: Dec. 15, 2008

(30) Foreign Application Priority Data
Dec. 17, 2007 (JP) 2007-325212
Dec. 1, 2008 (JP) 2008-306781

(51) Int. Cl. G03B 27/32; G03B 27/52

(52) U.S. Cl. 355/27; 355/30

(57) ABSTRACT

A positioning apparatus includes a movable member, a support member which supports the movable member, a driving mechanism which moves the movable member supported by the support member, a first temperature regulating unit which regulates the temperature of the driving mechanism, and a second temperature regulating unit which regulates the temperature of the support member on the basis of the information provided from the first temperature regulating unit.

### BACKGROUND OF THE INVENTION

1. Field of the Invention

The present invention relates to a positioning apparatus which positions a movable member, an exposure apparatus having the positioning apparatus, and a device manufacturing method of manufacturing a device using the exposure apparatus.

2. Description of the Related Art

An exposure apparatus which projects and transfers a pattern formed on a reticle onto a substrate coated with a resist (photosensitive agent) is employed in a semiconductor device manufacturing process. Along with an improvement in the packing density of semiconductor devices, further advance of micropatterning is required. The exposure apparatus has coped with the advance of micropatterning along with the development of the resist process.

In the exposure apparatus, the amount of heat generated by a linear motor for driving a stage increases along with an increase in the throughput of the exposure apparatus. The linear motor is cooled using a refrigerant such as water, antifreeze, or inert liquid. The refrigerant the temperature of which has risen upon absorbing the heat generated by the linear motor is cooled by heat exchange with cold water, and is then precisely temperature-regulated by a precision heater near a heat generating portion.

In order to suppress heat generation due to friction between a feed screw and nut for driving a table, Japanese Patent Laid-Open No. 5-126972 discloses a technique of providing a temperature regulating member integrated with the nut to control the temperature of a fluid supplied to the temperature regulating member in accordance with the operating state of the table.

Unfortunately, although the conventional arrangement can regulate the temperature of the heat generating portion itself, it cannot control the temperature of a member heated by the heat that has leaked from the heat generating portion.

For example, assume that a nonuniform temperature distribution is generated in a surface plate which supports the stage due to the heat that has leaked from the linear motor. In this case, a measurement device which measures the position of the stage may deform or tilt and therefore generate a measurement error, resulting in deterioration in the stage positioning accuracy.

Furthermore, if an eddy current is generated in the surface plate due to a magnetic field that has leaked from the linear motor, it may heat the surface plate.

### SUMMARY OF THE INVENTION

The present invention has been made in consideration of the above-described problems, and has as its object to suppress a fluctuation in the temperature of a support member, that may occur upon operating, for example, a driving mechanism which drives a movable member on the support member.

According to the first aspect of the present invention, there is provided a positioning apparatus including a movable member, a support member which supports the movable member, and a driving mechanism which moves the movable member supported by the support member, comprising a first temperature regulating unit configured to regulate a temperature of the driving mechanism, and a second temperature regulating unit configured to regulate a temperature of the support member based on information provided from the first temperature regulating unit.

According to the second aspect of the present invention, there is provided a positioning apparatus including a movable member, a support member which supports the movable member, and a driving mechanism which moves the movable member supported by the support member, comprising a driving control unit configured to control an operation of the driving mechanism, and a temperature regulating unit configured to regulate a temperature of the support member on the basis of the information provided from the driving control unit.

According to the third aspect of the present invention, there is provided a positioning apparatus including a movable member, a support member which supports the movable member, and a driving mechanism which moves the movable member supported by the support member, comprising a plurality of temperature sensors configured to detect a temperature of the support member at different positions, and a temperature regulator configured to regulate the temperature of the support member in accordance with a variation among the plurality of temperature detection results respectively output from the plurality of temperature sensors.

According to the forth aspect of the present invention, there is provided a positioning apparatus including a movable member, a support member which supports the movable member, and a driving mechanism including a linear motor which moves the movable member supported by the support member, comprising a first temperature regulating unit configured to regulate a temperature of the driving mechanism, the first temperature regulating unit including a passage configured to supply a refrigerant to the driving mechanism, a temperature sensor configured to detect a temperature of the refrigerant, and a first temperature regulator configured to regulate the temperature of the refrigerant so that the temperature detected by the temperature sensor becomes a target temperature; and a second temperature regulating unit configured to regulate a temperature of the support member, the second temperature regulating unit including a passage configured to supply a refrigerant to the support member, and a second temperature regulator configured to regulate a temperature of the refrigerant supplied to the passage, wherein the second temperature regulator regulates the temperature of the refrigerant supplied to the support member based on one of the detection result obtained by the temperature sensor and a manipulated value in the first temperature regulator.

According to the fifth aspect of the present invention, there is provided an exposure apparatus which projects a pattern of an original onto a substrate, thereby exposing the substrate, and comprises the above-defined positioning apparatus as at least one of an apparatus which positions the original, and an apparatus which positions the substrate.

According to the sixth aspect of the present invention, there is provided a device manufacturing method comprising the steps of exposing a substrate to light by the above-defined exposure apparatus, and developing the substrate.

According to the present invention, it is possible to suppress a fluctuation in the temperature of a support member, that may occur upon operating, for example, a driving mechanism which drives a movable member on the support member.

Further features of the present invention will become apparent from the following description of exemplary embodiments with reference to the attached drawings.

### BRIEF DESCRIPTION OF THE DRAWINGS

FIG. 1 is a view showing the schematic arrangement of a positioning apparatus and exposure apparatus according to the first embodiment of the present invention;

FIGS. 2A to 2E are timing charts exemplifying the states of a first temperature regulating unit TRU1 and second temperature regulating unit TRU2 in the positioning apparatus and exposure apparatus shown in FIG. 1;

FIG. 3 is a view showing the schematic arrangement of a positioning apparatus and exposure apparatus according to the second embodiment of the present invention;

FIG. 4 is a view showing the schematic arrangement of a positioning apparatus and exposure apparatus according to the third embodiment of the present invention;

FIG. 5 is a view showing the schematic arrangement of a positioning apparatus and exposure apparatus according to the fourth embodiment of the present invention;

FIGS. 6A and 6B are views showing an arrangement example of circulating passages running inside a support member;

FIG. 7 is a view showing the schematic arrangement of a positioning apparatus and exposure apparatus according to the fifth embodiment of the present invention; and

FIG. 8 is a view showing the schematic arrangement of an exposure apparatus according to a preferred embodiment of the present invention.

### DESCRIPTION OF THE EMBODIMENTS

Preferred embodiments of the present invention will be described below with reference to the accompanying drawings.

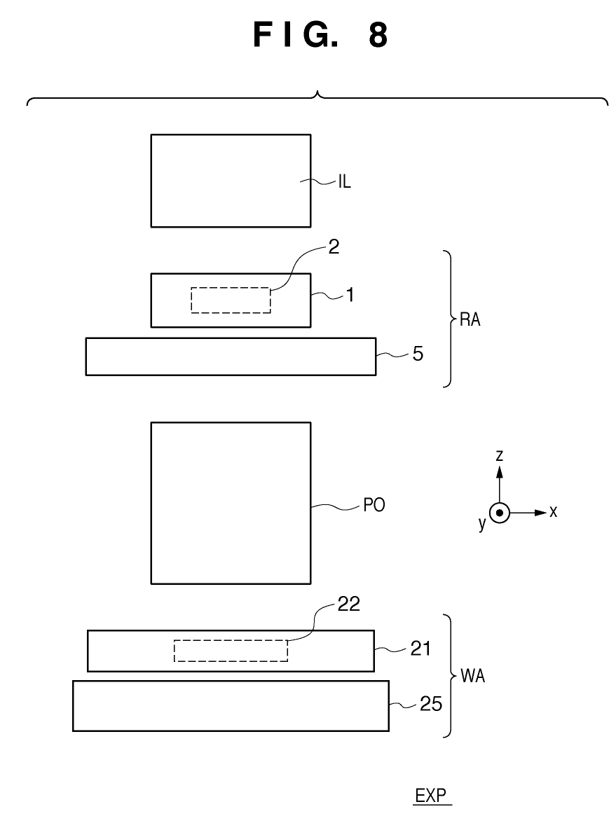

FIG. 8 is a view showing the schematic arrangement of an exposure apparatus according to a preferred embodiment of the present invention. An exposure apparatus EXP according to the preferred embodiment of the present invention projects the pattern of a reticle (original) illuminated by an illumination optical system IL onto a wafer (substrate) by a projection optical system PO, thereby exposing the wafer. The reticle is positioned by a reticle positioning apparatus RA. The reticle positioning apparatus RA includes a reticle stage (original stage) 2 serving as a movable member which holds and moves the reticle, a support member (surface plate) 5 which supports the reticle stage 2, and a driving mechanism 1 which moves the reticle stage 2 supported by the support member 5. The driving mechanism 1 can include, for example, an electromagnetic actuator such as a linear motor. The wafer is positioned by a wafer positioning mechanism WA. The wafer positioning mechanism WA includes a wafer stage (substrate stage) 22 serving as a movable member which holds and moves the wafer, a support member (surface plate) 25 which supports the wafer stage 22, and a driving mechanism 21 which moves the wafer stage 22 supported by the support member 25. The driving mechanism 21 can include, for example, an electromagnetic actuator such as a linear motor.

The exposure apparatus according to the present invention can be practiced as, for example, a scanning exposure apparatus or an exposure apparatus which exposes the substrate while the substrate and original stand still. Also, the exposure apparatus according to the present invention can be practiced as, for example, an immersion exposure apparatus which exposes the substrate by filling the space between the projection optical system and the substrate with a liquid, or an exposure apparatus which exposes the substrate without using any liquid.

The positioning apparatus according to the present invention is suitable as, for example, at least one of the reticle positioning apparatus RA and the wafer positioning mechanism WA. Although a case in which the positioning apparatus according to the present invention is applied to the reticle positioning apparatus RA will be exemplified hereinafter, the positioning apparatus according to the present invention is also applicable to the wafer positioning mechanism WA.

The positioning apparatus according to the present invention is not particularly limited to a constituent component of an exposure apparatus, and is applicable to all positioning apparatuses having driving mechanisms and support members.

Preferred embodiments of the present invention will be exemplified below.

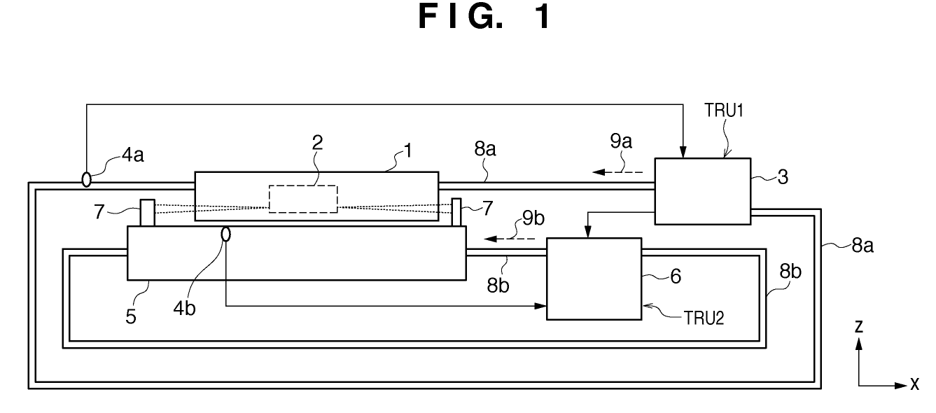

FIG. 1 is a view showing the schematic arrangement of a positioning apparatus and exposure apparatus according to the first embodiment of the present invention. In this embodiment, the positioning apparatus according to the present invention is applied to the reticle positioning apparatus RA of the exposure apparatus EXP shown in FIG. 8.

A reticle positioning apparatus RA includes a reticle stage 2 serving as a movable member which holds a reticle, a driving mechanism (e.g., a linear motor) 1 which drives the reticle stage 2 in the x-axis direction, and a first temperature regulating unit TRU1 which regulates the temperature of the driving mechanism 1. The reticle positioning apparatus RA also includes a second temperature regulating unit TRU2 which regulates the temperature of a support member 5 which supports the reticle stage 2. The second temperature regulating unit TRU2 regulates the temperature of the support member 5 on the basis of the information provided from the first temperature regulating unit TRU1.

The first temperature regulating unit TRU1 includes a circulating passage 8a through which a refrigerant for controlling the temperature of the driving mechanism 1 flows, a temperature sensor 4a which detects the temperature of the refrigerant flowing through the circulating passage 8a, and a temperature regulator 3 which regulates, based on the output from the temperature sensor 4a, the temperature of the refrigerant supplied to the circulating passage 8a. The refrigerant flows in the direction indicated by an arrow 9a. The temperature sensor 4a can be set so as to detect the temperature of the refrigerant on, e.g., the exit side (downstream side) of the driving mechanism 1.

The second temperature regulating unit TRU2 includes a circulating passage 8b through which a refrigerant for regulating the temperature of the support member 5 flows, a temperature sensor 4b which detects the temperature of the support member 5, and a temperature regulator 6 which regulates the temperature of the refrigerant supplied to the circulating passage 8b. The second temperature regulating unit TRU2 regulates the temperature of the refrigerant supplied to the circulating passage 8b (consequently, the temperature of the support member 5), based on the information provided from the first temperature regulating unit TRU1. The temperature sensor 4b can be built in, for example, the support member 5. In the circulating passage 8b, the refrigerant flows in the direction indicated by an arrow 9b.

The support member 5 mounts a laser interferometer (an example of the measurement device) 7 which measures the position of the reticle stage 2.

The refrigerants supplied to the circulating passages 8a and 8b each can be, for example, a liquid such as pure water, antifreeze, or fluorinated inert liquid, or a gas such as air or nitrogen gas.

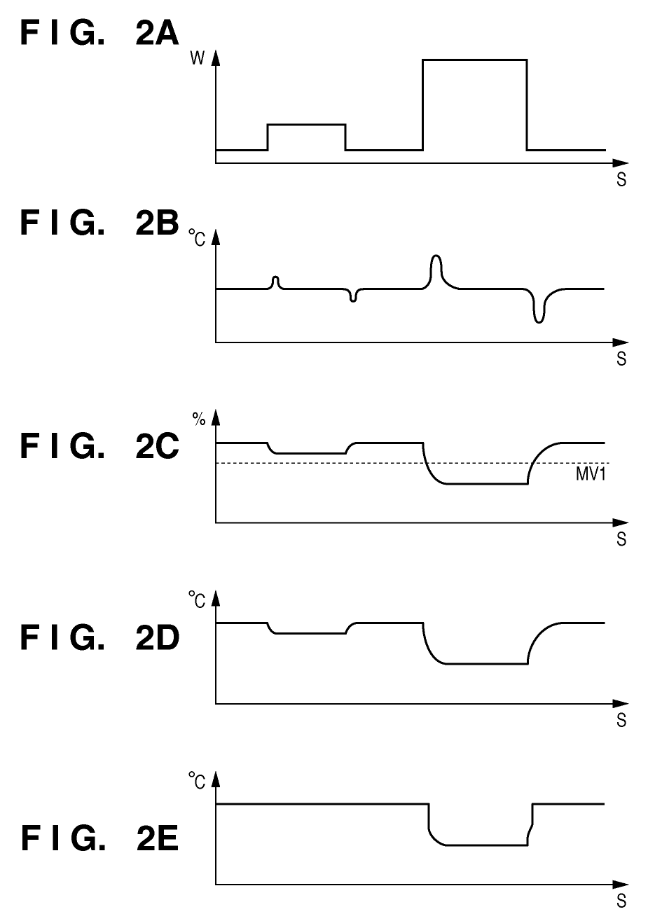

FIGS. 2A to 2E are timing charts exemplifying the states of the first temperature regulating unit TRU1 and second temperature regulating unit TRU2 in the positioning apparatus and exposure apparatus shown in FIG. 1.

FIG. 2A exemplifies a change in the power consumption of the driving mechanism (e.g., a linear motor) 1 as a heat generating source. Referring to FIG. 2A, the abscissa indicates the time (s), and the ordinate indicates the power consumption (W). FIG. 2B exemplifies a change in the temperature detected by the temperature sensor 4a when power is consumed as shown in FIG. 2A. Referring to FIG. 2B, the abscissa indicates the time (s), and the ordinate indicates the temperature (° C.). The temperature regulator 3 of the first temperature regulating unit TRU1 controls the temperature detected by the temperature sensor 4a to a target temperature. In this example, the temperature sensor 4a is set so as to detect the temperature of the refrigerant on, for example, the exit side (downstream side) of the driving mechanism 1.

The temperature of the driving mechanism 1 is controlled by regulating the temperature of the refrigerant flowing through the circulating passage 8a by the first temperature regulating unit TRU1 using, for example, feedback control in accordance with the heat generation state of the driving mechanism 1. However, the driving mechanism 1 naturally cannot be regulated to have a uniform temperature as a whole, so it has a temperature gradient, that is, a certain portion in it has a locally high temperature and the temperature around its entrance for the refrigerant is low. Owing to the nonuniform temperature, part of heat is conducted to the support member 5 by way of heat conduction or radiation. The temperature of the support member 5 is regulated by the refrigerant flowing through the circulating passage 8b by the second temperature regulating unit TRU2, but the support member 5 is adversely affected by the heat conducted to it at the same time. The support member 5 may expand or contract due to a change in the temperature of a part of the support member 5. The laser interferometer 7 is mounted on the support member 5, so the fixing member for fixing the laser interferometer 7 deforms due to a change in the length of the support member 5 upon its expansion or contraction or a change in the force applied to the fixing member. When this occurs, the laser interferometer 7 is misaligned or tilted, resulting in the generation of an error in the length measurement result. The magnitude of the length measurement error due to a change in the temperature of the support member 5 and the heat generation amount of the driving mechanism 1 have a correlation. In view of this, the target temperature of the second temperature regulating unit TRU2 which regulates the temperature of the support member 5 is changed in accordance with the heat generation amount of the driving mechanism 1 to change the temperature of the support member 5, thereby canceling the length measurement error due to the heat conducted from the driving mechanism 1. Assume, for example, that the temperature of a part of the support member 5 has risen upon heat generation of the driving mechanism, so the value of the length measurement result has increased. In this case, the expansion of the support member 5 is canceled by decreasing the target temperature of the second temperature regulating unit TRU2 to, in turn, correct the error in the length measurement result obtained by the laser interferometer 7.

The heat generation amount of the driving mechanism 1 can be predicted based on, for example, the manipulated value in the temperature regulator 3 and the temperature sensor 4a which detects the temperature of the refrigerant. Using this information, the target temperature of the second temperature regulating unit TRU2 is changed.

FIG. 2C exemplifies a change in the manipulated value (%) in the temperature regulator 3. The abscissa indicates the time (s), and the ordinate indicates the manipulated value (%). The temperature regulator 3 can include, for example, a heat exchanger which cools the refrigerant, and a heater which heats the refrigerant cooled by the heat exchanger. The manipulated value can be of, for example, the heater. In this example, the manipulated value decreases in decreasing the temperature of the refrigerant (in decreasing the calorific value of the heater), and it increases in increasing the temperature of the refrigerant (in increasing the calorific value of the heater). In this embodiment, the temperature regulator 3 controls to suppress an increase in the temperature of the support member 5 due to heat generation by the driving mechanism 1. Therefore, the larger the power consumption of the driving mechanism 1, the smaller the manipulated value.

FIG. 2D exemplifies the target temperature changed by the temperature regulator 6 in response to a change in the manipulated value (%) in the temperature regulator 3. The abscissa indicates the time (s), and the ordinate indicates the target temperature (° C.). Even when the temperature of the driving mechanism 1 is controlled by the first temperature regulating unit TRU1, a portion different from the driving mechanism 1 as a heat generating source may thermally fluctuate due to, for example, heat conduction, radiant heat, or eddy current. This causes an error of the measurement result obtained by the laser interferometer 7 mounted on the support member 5. To avoid this situation, in this embodiment, the target temperature of the support member 5 different from the driving mechanism 1 as a heat generating source is provided from the first temperature regulating unit TRU1 (temperature regulator 3) which regulates the temperature of the driving mechanism 1 to the second temperature regulating unit TRU2 (temperature regulator 6). For example, the target temperature is determined based on information (e.g., the manipulated value) to control the temperature of the driving mechanism 1 by the first temperature regulating unit TRU1. This reduces the influence of the operation of the driving mechanism 1 on the measurement by the laser interferometer 7.

FIG. 2E exemplifies another example of the target temperature changed by the temperature regulator 6 in response to a change in the manipulated value (%) in the temperature regulator 3. If the manipulated value (%) in the temperature regulator 3 is always taken into consideration in determining the target value in the temperature regulator 6 as exemplified in FIG. 2D, the temperature stability of the support member 5 may deteriorate when the driving mechanism 1 is in a non-operative state or low heat generation state. To avoid this situation, as exemplified in FIG. 2E, the target temperature in the temperature regulator 6 is desirably changed only when a change in the manipulated value has deviated from a threshold value MV1 shown in FIG. 2C.

Temperature sensors 4a may be set on, for example, both sides, that is, the exit side (downstream side) and entrance side (upstream side) of the driving mechanism 1. In this case, the temperature regulator 3 can control the temperature of the driving mechanism 1 on the basis of the average of the temperatures of the refrigerant on the exit side (downstream side) and entrance side (upstream side) of the driving mechanism 1.

The information which is provided from the first temperature regulating unit TRU1 to the second temperature regulating unit TRU2 and used to regulate the temperature of the support member 5 by the second temperature regulating unit TRU2 may be, for example, the temperature of the refrigerant supplied to the driving mechanism 1. This temperature can be measured by, for example, a temperature sensor which can be built in, for example, the temperature regulator 3.

When the temperature of the refrigerant supplied to the driving mechanism 1 is maintained constant by the first temperature regulating unit TRU1, the second temperature regulating unit TRU2 may perform temperature control based on the temperature detected by the temperature sensor 4a set on the exit side of the driving mechanism 1.

The reasons why the second temperature regulating unit TRU2 regulates the temperature of the support member 5 based on the information provided from the first temperature regulating unit TRU1 without independently regulating it are as follows.

First, it is difficult to accommodate a large number of temperature sensors in the support member 5. As a matter of course, when a large number of temperature sensors are accommodated in the support member 5, the second temperature regulating unit TRU2 can exhibit the same performance as in this embodiment by controlling the temperature of the support member 5 based on the pieces of information obtained by the temperature sensors. However, an actual apparatus can hardly ensure the space to accommodate a large number of temperature sensors in the support member.

Second, the support member 5 must have a size enough to support, for example, a stage.

In contrast to the above-mentioned case, a case in which the temperature at a certain position (for example, the center) in the support member 5 serving as a representative point is measured, and the temperature of the support member 5 is regulated based on the measurement result will be considered. In this case, the temperature around the representative point is regulated precisely. However, as described above, because the support member 5 has a size enough to support, for example, a stage, it is difficult to precisely regulate the temperature at a position away from the representative point although the temperature at the representative point is regulated precisely. For this reason, the support member 5 has a significantly high temperature gradient as a whole.

To avoid this situation, information provided from the first temperature regulating unit TRU1 is used in this embodiment so that a change in the temperature of the support member 5 can be determined based on not a point but a region having a certain size. This makes it possible to reduce a change in the temperature of the support member 5 without accommodating a large number of temperature sensors in it.

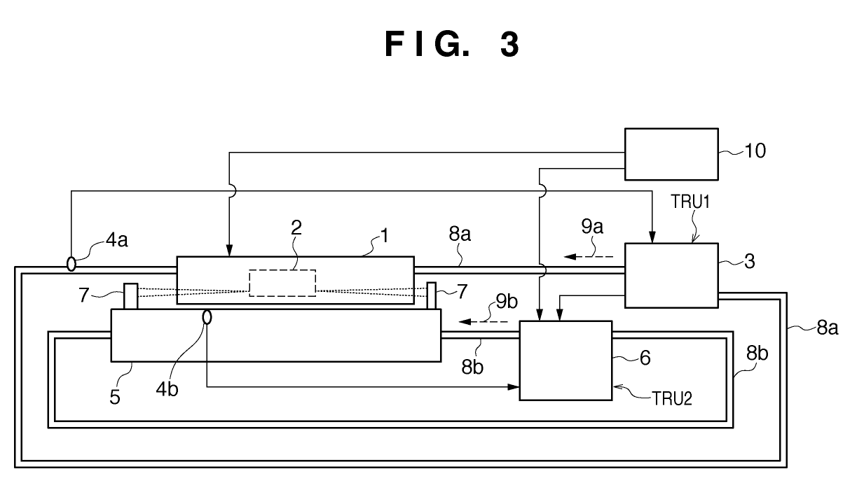

FIG. 3 is a view showing the schematic arrangement of a positioning apparatus and exposure apparatus according to the second embodiment of the present invention. In this embodiment, the positioning apparatus according to the present invention is applied to the reticle positioning apparatus RA of the exposure apparatus EXP shown in FIG. 8. The same reference numerals as in FIG. 1 denote the same or similar constituent elements in FIG. 3.

A reticle positioning apparatus RA includes a driving control unit 10 which controls the operation of a driving mechanism 1 (the driving of a reticle stage 2). Driving information to control the driving mechanism 1 is provided from the driving control unit 10 to a second temperature regulating unit TRU2. Based on this driving information, the second temperature regulating unit TRU2 determines the target temperature of a support member 5, and regulates the temperature of the support member 5 to the target temperature.

The support member 5 which supports the reticle stage 2 has a relatively large mass, so its temperature control is likely to be delayed. However, the above-described arrangement can reduce a change in the temperature of the support member 5 attributed to the operation of the driving mechanism 1. The driving information is preferably provided from the driving control unit 10 to the second temperature regulating unit TRU2 prior to the driving of the driving mechanism 1. More specifically, in operating the driving mechanism 1 in accordance with a certain driving pattern, the operation of the driving mechanism 1 is preferably started in accordance with the driving pattern after the start of the operation of the reticle stage 2 in accordance with the driving pattern.

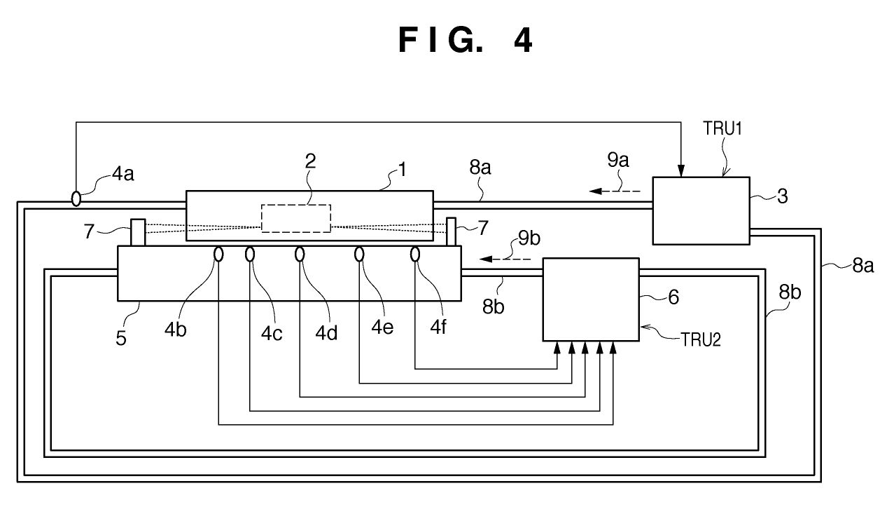

FIG. 4 is a view showing the schematic arrangement of a positioning apparatus and exposure apparatus according to the third embodiment of the present invention. In this embodiment, the positioning apparatus according to the present invention is applied to the reticle positioning apparatus RA of the exposure apparatus EXP shown in FIG. 8. The same reference numerals as in FIG. 1 denote the same or similar constituent elements in FIG. 4.

A plurality of temperature sensors 4b, 4c, 4d, 4e, and 4f are built in a support member 5. A temperature regulator 6 of a second temperature regulating unit TRU2 regulates the temperature of the support member 5 based on the temperatures provided from the plurality of temperature sensors 4b to 4f.

The moving distance of a reticle stage 2 which moves while being supported by the support member 5 changes depending on conditions such as the shot size, the acceleration of the reticle stage 2, and the velocity of the reticle stage 2 during wafer exposure. For example, if the shot size is small, the acceleration of the reticle stage 2 is high, and the velocity of the reticle stage 2 is low, the moving distance of the reticle stage 2 is short. In contrast, if the shot size is large, the acceleration of the reticle stage 2 is low, and the velocity of the reticle stage 2 is high, the moving distance of the reticle stage 2 is long. The change in the moving distance of the reticle stage 2 amounts to a change in the heat transfer path from a driving mechanism 1 to the support member 5. The change in the moving distance of the reticle stage 2 also leads to a change in the density of heat transferred from the driving mechanism 1 to the support member 5.

The influence of heat that has leaked from the driving mechanism 1 mainly appears in a region where the reticle stage 2 is accelerated and decelerated, and heat generation due to an eddy current appears in a region where the reticle stage 2 moves. For this reason, a nonuniform temperature distribution or temperature gradient is formed in the support member 5. A variation (e.g., the difference between a maximum value and minimum value) among the temperature detection results output from the plurality of temperature sensors 4b to 4f while the reticle stage 2 is moved is larger than that while the reticle stage 2 is stopped. Based on the magnitude of this temperature difference, the heat generation of the support member 5 can be detected. In view of this, in the third embodiment, the temperature regulator 6 of the second temperature regulating unit TRU2 determines the target temperature of the refrigerant in accordance with a variation among the temperature detection results output from the plurality of temperature sensors 4b to 4f, and regulates the temperature of the support member 5.

A temperature sensor cannot always be set at an optimal position. To cope with this situation, the temperature detection result obtained by the temperature sensor may be corrected by multiplying it by a coefficient involved.

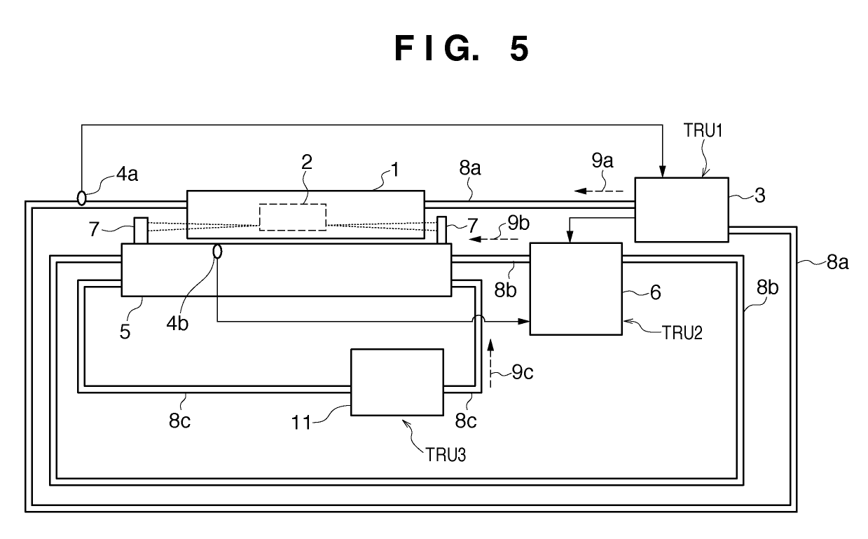

FIG. 5 is a view showing the schematic arrangement of a positioning apparatus and exposure apparatus according to the fourth embodiment of the present invention. In this embodiment, the positioning apparatus according to the present invention is applied to the reticle positioning apparatus RA of the exposure apparatus EXP shown in FIG. 8. The same reference numerals as in FIG. 1 denote the same or similar constituent elements in FIG. 5.

A reticle positioning apparatus RA includes a third temperature regulating unit TRU3 which regulates the temperature of a support member 5, separately from a second temperature regulating unit TRU2. The second temperature regulating unit TRU2 can be the same as in the first to third embodiments. The third temperature regulating unit TRU3 includes a circulating passage 8c through which a refrigerant for regulating the temperature of the support member 5 flows, and a temperature regulator 11 which regulates the temperature of the refrigerant supplied to the circulating passage 8c to a target temperature. The temperature regulator 11 supplies, for example, a refrigerant that is always regulated at a constant temperature to the circulating passage 8c which runs through the support member 5.

The second temperature regulating unit TRU2 can regulate the temperature of a first portion of the support member 5, which is susceptible to heat generated as a reticle stage 2 moves. The third temperature regulating unit TRU3 can regulate the temperature of a second portion of the support member 5, which is less susceptible to heat generated as the reticle stage 2 moves than the first portion.

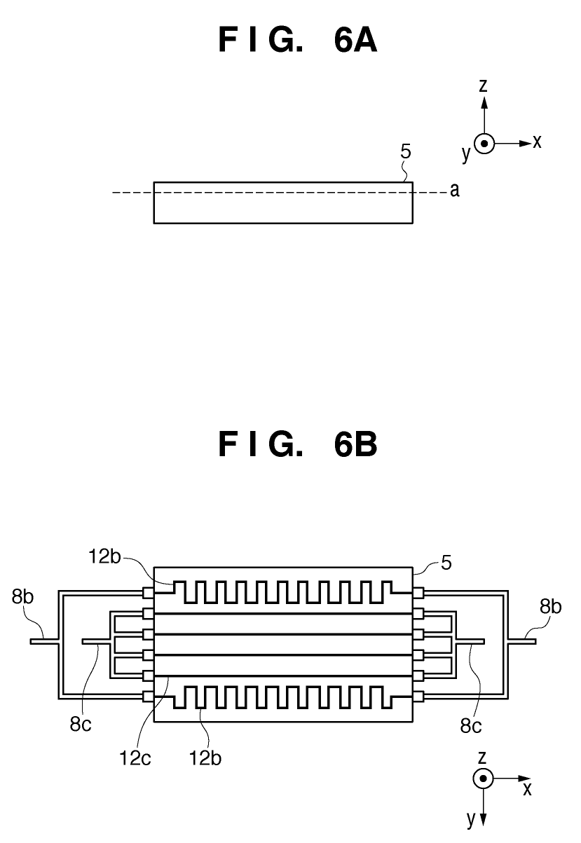

FIGS. 6A and 6B are views showing arrangement examples of a circulating passage 8b and the circulating passage 8c in the support member 5. FIG. 6A is a side view of the support member 5, and FIG. 6B is a sectional view showing the arrangement of the circulating passages 8b and 8c taken along a plane a in FIG. 6A. A passage 12b is a portion of the circulating passage 8b, which runs inside the support member 5. A passage 12c is a portion of the circulating passage 8c, which runs inside the support member 5.

In general, the two end portions (examples of the first portion) of the support member 5 which supports the reticle stage 2 receive larger amounts of heat from a driving mechanism 1 than the middle portion (an example of the second portion) of the support member 5. The second portion can be defined as, for example, the portion sandwiched between the two first portions. The circulating passage 8b of the second temperature regulating unit TRU2 can be set to run through the first portions of the support member 5. The circulating passage 8c of the third temperature regulating unit TRU3 can be set to run through the second portion of the support member 5.

The first portion and second portion are not particularly limited to the above-described example. For example, the first portion and second portion may be determined such that their positions in the z-axis direction (optical axis direction) differ from each other.

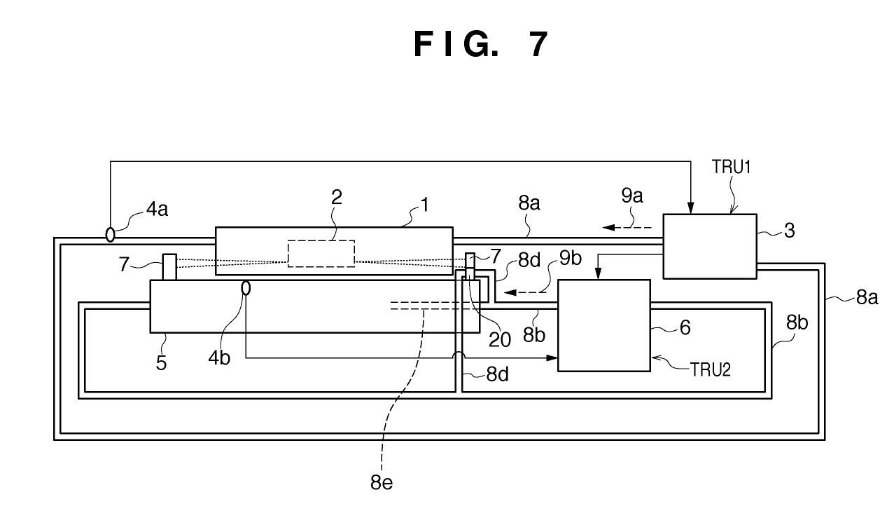

FIG. 7 is a view showing the schematic arrangement of a positioning apparatus and exposure apparatus according to the fifth embodiment. In this embodiment, the positioning apparatus according to the present invention is applied to the reticle positioning apparatus RA of the exposure apparatus EXP shown in FIG. 8. The same reference numerals as in FIG. 1 denote the same or similar constituent elements in FIG. 7.

A second temperature regulating unit TRU2 can be the same as in the first to fourth embodiments. The second temperature regulating unit TRU2 supplies a refrigerant to a first passage 8e which runs inside a support member 5, and a second passage 8d which runs inside a fixing member 20 to fix a laser interferometer (measurement device) 7 to the support member 5 so as to measure the position of a reticle stage 2. In this embodiment, a circulating passage 8b branches into the first passage 8e and the second passage 8d.

If a difference occurs between the temperatures of the support member 5 and the fixing member 20 of the laser interferometer 7, the two members deform due to their difference in thermal expansion. This may result in a positional shift or tilt of the laser interferometer 7. Therefore, the temperatures of both the fixing member 20 and the support member 5 are preferably regulated, as described above.

In addition, the temperatures of members fixed to the support member 5, for example, optical members such as a corner cube and bar mirror may be regulated by temperature regulating units TRU.

A device manufacturing method according to the preferred embodiments of the present invention is suitable for the manufacture of devices (e.g., a semiconductor device and liquid crystal device). This method can include a step of exposing a substrate coated with a photoresist to light by using the above exposure apparatus, and a step of developing the substrate exposed in the exposing step. In addition to the above steps, the device manufacturing method can include other known steps (e.g., oxidation, film forming, evaporation, doping, planarization, etching, resist removing, dicing, bonding, and packaging steps).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2007-325212 filed on Dec. 17, 2007 and 2008-306781 filed on Dec. 1, 2008, which are hereby incorporated by reference herein in their entirety.

What is claimed:

1. A positioning apparatus including a movable member, a support member which supports the movable member, and a driving mechanism which moves the movable member supported by the support member, comprising:
a first temperature regulating unit configured to regulate a temperature of the driving mechanism; and
a second temperature regulating unit configured to regulate a temperature of the support member based on information provided from said first temperature regulating unit.

2. The apparatus according to claim 1, wherein the information provided from said first temperature regulating unit to said second temperature regulating unit includes information to control the temperature of the driving mechanism by said first temperature regulating unit.

3. The apparatus according to claim 1, wherein said second temperature regulating unit is configured to supply a refrigerant to a first passage which runs inside the support member, and a second passage which runs inside a fixing member to fix a measurement device to the support member so as to measure a position of the movable member.

4. A positioning apparatus including a movable member, a support member which supports the movable member, and a driving mechanism which moves the movable member supported by the support member, comprising:
a driving control unit configured to control an operation of the driving mechanism; and
a temperature regulating unit configured to regulate a temperature of the support member on the basis of the information provided from said driving control unit.

5. The apparatus according to claim 4, wherein said temperature regulating unit is configured to supply a refrigerant to a first passage which runs inside the support member, and a second passage which runs inside a fixing member to fix a measurement device to the support member so as to measure a position of the movable member.

6. A positioning apparatus including a movable member, a support member which supports the movable member, and a driving mechanism which moves the movable member supported by the support member, comprising:
a plurality of temperature sensors configured to detect a temperature of the support member at different positions; and
a temperature regulator configured to regulate the temperature of the support member in accordance with a variation among the plurality of temperature detection results respectively output from said plurality of temperature sensors.

7. A positioning apparatus including a movable member, a support member which supports the movable member, and a driving mechanism including a linear motor which moves the movable member supported by the support member, comprising:
a first temperature regulating unit configured to regulate a temperature of the driving mechanism, said first temperature regulating unit including a passage configured to supply a refrigerant to the driving mechanism, a temperature sensor configured to detect a temperature of the refrigerant, and a first temperature regulator configured to regulate the temperature of the refrigerant so that the temperature detected by said temperature sensor becomes a target temperature; and
a second temperature regulating unit configured to regulate a temperature of the support member, said second temperature regulating unit including a passage configured to supply a refrigerant to the support member, and a second temperature regulator configured to regulate a temperature of the refrigerant supplied to said passage,
wherein said second temperature regulator regulates the temperature of the refrigerant supplied to the support member based on one of the detection result obtained by said temperature sensor and a manipulated value in said first temperature regulator.

8. An exposure apparatus which projects a pattern of an original onto a substrate, thereby exposing the substrate, and comprises a positioning apparatus as at least one of an apparatus which positions the original, and an apparatus which positions the substrate,
the positioning apparatus including a movable member, a support member which supports the movable member, a driving mechanism which moves the movable member supported by the support member, a first temperature regulating unit configured to regulate a temperature of the driving mechanism, and a second temperature regulating unit configured to regulate a temperature of the support member based on information provided from the first temperature regulating unit.

9. A device manufacturing method comprising the steps of:
exposing a substrate to light by an exposure apparatus; and
developing the substrate,
wherein the exposure apparatus is configured to project a pattern of an original onto a substrate, thereby exposing the substrate and comprises a positioning apparatus as at least one of an apparatus which positions the original, and an apparatus which positions the substrate,
the positioning apparatus including a movable member, a support member which supports the movable member, a driving mechanism which moves the movable member supported by the support member, a first temperature regulating unit configured to regulate a temperature of the driving mechanism, and a second temperature regulating unit configured to regulate a temperature of the support member based on information provided from the first temperature regulating unit.

10. An exposure apparatus which projects a pattern of an original onto a substrate, thereby exposing the substrate, and comprises a positioning apparatus as at least one of an apparatus which positions the original, and an apparatus which positions the substrate,
the positioning apparatus including a movable member, a support member which supports the movable member, a driving mechanism which moves the movable member supported by the support member, a driving control unit configured to control an operation of the driving mechanism, and a temperature regulating unit configured to regulate a temperature of the support member on the basis of the information provided from the driving control unit.

11. A device manufacturing method comprising the steps of:
exposing a substrate to light by an exposure apparatus; and
developing the substrate,
wherein the exposure apparatus is configured to project a pattern of an original onto a substrate, thereby exposing the substrate, and comprises a positioning apparatus as at least one of an apparatus which positions the original, and an apparatus which positions the substrate,
the positioning apparatus including a movable member, a support member which supports the movable member, a driving mechanism which moves the movable member supported by the support member, a driving control unit configured to control an operation of the driving mechanism, and a temperature regulating unit configured to regulate a temperature of the support member on the basis of the information provided from the driving control unit.

12. An exposure apparatus which projects a pattern of an original onto a substrate, thereby exposing the substrate, and comprises a positioning apparatus as at least one of an apparatus which positions the original, and an apparatus which positions the substrate,
the positioning apparatus including a movable member, a support member which supports the movable member, a driving mechanism which moves the movable member supported by the support member, a plurality of temperature sensors configured to detect a temperature of the support member at different positions, and a temperature regulator configured to regulate the temperature of the support member in accordance with a variation among the plurality of temperature detection results respectively output from the plurality of temperature sensors.

13. A device manufacturing method comprising the steps of:
exposing a substrate to light by an exposure apparatus; and
developing the substrate,
wherein the exposure apparatus is configured to project a pattern of an original onto a substrate, thereby exposing the substrate, and comprises a positioning apparatus as at least one of an apparatus which positions the original, and an apparatus which positions the substrate,
the positioning apparatus including a movable member, a support member which supports the movable member, a driving mechanism which moves the movable member supported by the support member, a plurality of temperature sensors configured to detect a temperature of the support member at different positions, and a temperature regulator configured to regulate the temperature of the support member in accordance with a variation among the plurality of temperature detection results respectively output from said plurality of temperature sensors.

14. An exposure apparatus which projects a pattern of an original onto a substrate, thereby exposing the substrate, and comprises a positioning apparatus as at least one of an apparatus which positions the original, and an apparatus which positions the substrate,
the positioning apparatus including a movable member; a support member which supports the movable member; and a driving mechanism including a linear motor which moves the movable member supported by the support member; a first temperature regulating unit configured to regulate a temperature of the driving mechanism, the first temperature regulating unit including a passage configured to supply a refrigerant to the driving mechanism, a temperature sensor configured to detect a temperature of the refrigerant, and a first temperature regulator configured to regulate the temperature of the refrigerant so that the temperature detected by said temperature sensor becomes a target temperature; and a second temperature regulating unit configured to regulate a temperature of the support member, the second temperature regulating unit including a passage configured to supply a refrigerant to the support member, and a second temperature regulator configured to regulate a temperature of the refrigerant supplied to the passage, wherein the second temperature regulator regulates the temperature of the refrigerant supplied to the support member based on one of the detection result obtained by the temperature sensor and a manipulated value in the first temperature regulator.

15. A device manufacturing method comprising the steps of:
exposing a substrate to light by an exposure apparatus; and
developing the substrate,
wherein the exposure apparatus is configured to project a pattern of an original onto a substrate, thereby exposing the substrate, and comprises a positioning apparatus as at least one of an apparatus which positions the original, and an apparatus which positions the substrate,
the positioning apparatus including a movable member; a support member which supports the movable member; and a driving mechanism including a linear motor which moves the movable member supported by the support member; a first temperature regulating unit configured to regulate a temperature of the driving mechanism, the first temperature regulating unit including a passage configured to supply a refrigerant to the driving mechanism, a temperature sensor configured to detect a temperature of the refrigerant, and a first temperature regulator configured to regulate the temperature of the refrigerant so that the temperature detected by said temperature sensor becomes a target temperature; and a second temperature regulating unit configured to regulate a temperature of the support member, the second temperature regulating unit including a passage configured to supply a refrigerant to the support member, and a second temperature regulator configured to regulate a temperature of the refrigerant supplied to the passage, wherein the second temperature regulator regulates the temperature of the refrigerant supplied to the support member based on one of the detection result obtained by the temperature sensor and a manipulated value in the first temperature regulator.
